(19) United States
(12) Patent Application Publication
(10) Pub. No.: US 2008/0129867 A1
(43) Pub. Date: Jun. 5, 2008

(54) Closed caption timecode

(76) Inventors: Benjamin Montua, Koln (DE); Armin Barbalata, Munchen (DE)

Correspondence Address: Raymond R. Ferrera, 1221 McKinney Street, Suite 4400, Houston, TX, 77010, US

(21) Appl. No.: 11/983,927

(22) Filed: Nov. 13, 2007

Related U.S. Application Data
(60) Provisional application No. 60/865,654, filed on Nov. 14, 2006.

(51) Int. Cl. H04N 7/00

(52) U.S. Cl. 348/468; 348/E07.001

(57) ABSTRACT

This invention relates to the field of synchronizing overlay video signals with a television video signal feed, in order to allow the overlay video signals to be mixed with the television video signal feed at the proper time intervals. The synchronization is performed by using a synchronization signal which is encoded into the closed caption line of the television video signal feed.

### RELATED APPLICATION DATA

The instant application claims priority to prior provisional application No. 60/865,654, filed Nov. 14, 2006, still pending.

### TECHNICAL FIELD

This invention relates to the field of synchronizing overlay video signals with a television video signal feed, in order to allow the overlay video signals to be mixed with the television video signal feed at specific time intervals.

### BACKGROUND

Recent formats of television programs provide the viewer with the ability to get more information about what the viewer is watching or what is being advertised, along with the ability to buy it. In addition, some formats incorporate polls, questions, comments, and other forms of audience response back into the program. Often, the information itself or how to obtain the information as well as the invitation to participate in polls and the like are presented by inserting overlays into the television picture. These overlays, possibly adapted to the current circumstances, need to be inserted into the television picture at the appropriate time intervals of the program. This is especially necessary if, for example, the program is broadcast in various broadcasting areas in different time zones or if the program is repeated. In order to insert the overlays into the television picture at specific time intervals of the program, overlay video signals must be synchronized with a television video signal feed such that the overlay video signals are mixed with the television video signal feed at the proper time intervals.

Often the additional information or the polls and the like are provided by external suppliers so that systems of the external suppliers need to be synchronized with systems of the television stations. Unfortunately, no universal interface definition for accessing timing information of the television video signal feed exists. Furthermore, television stations' systems and scheduling software differ at least slightly from each other.

Accordingly, it is desirable and highly advantageous to have an avenue to synchronize overlay video signals with a television video signal feed, in order to allow the overlay video signals to be mixed with the television video signal feed at specific time intervals.

### SUMMARY OF THE INVENTION

Therefore, an aspect of the present invention is to provide a method, computer program product and system which allow overlay video signals to be synchronized with a television video signal feed such that the overlay video signals are mixed with the television video signal feed at the proper time intervals by using a synchronization signal which is encoded into the closed caption line of the television video signal feed.

The synchronization signal is indicative of the timing of the television video signal feed and is readable during playout of the television video signal feed in order to provide a reference for mixing overlay video signals with the television video signal feed.

According to an embodiment of the present invention, synchronizing overlay video signals with a television video signal feed comprises the actions of encoding a synchronization signal into the closed caption line of the television video signal feed during or after production of the television video signal feed, reading the synchronization signal during playout of the television video signal feed, and mixing overlay video signals with the television video signal feed based on the synchronization signal.

The synchronization signal is encoded into the closed caption line of the television video signal feed. The closed caption line is normally used for subtitles and belongs to the group of lines of the television video signal feed which are not used for the active picture area, i.e., the actual television picture. Most of these lines get filtered out of the original television video signal feed during compression when, for example, the television video signal feed is sent over a satellite. The active picture area can also be compressed, e.g., as MPEG-2. However, the closed caption line is preserved in almost every broadcast chain so that the synchronization signal encoded into the closed caption line remains unchanged and accessible during the broadcast process.

The closed caption line contains, among others, the fields C1-C4 and T1-T4. The synchronization signal can be encoded into each of these fields and it is selectable which field is used. This allows selecting a field of the closed caption line which is not used by another application, and which has the highest priority so that the accuracy of the synchronization signal is ensured.

The synchronization signal is preferably encoded into the closed caption line of the produced television video signal feed in a post-production step. Normally, the produced television video signal feed is recorded on tape or any other appropriate data storing medium and the synchronization signal is encoded into the closed caption line after the production of the television video signal feed. Alternatively, the encoding of the synchronization signal into the closed caption line is done during the production of the television video signal feed.

When the television video signal feed is to be broadcast, the produced television video signal feed including the synchronization signal is played in a pre-broadcast step, for example, in a playout center of a television broadcaster. During the playout, the synchronization signal encoded into the produced television video signal feed is read.

The information given in the synchronization signal is compared with a schedule. The schedule which is preferably stored in a database contains information regarding the insertion of overlays into television programs. The entries of the schedule use the information given in the synchronization signal as a reference to planning information. The planning information of an entry of the schedule contains a reference to overlay video signals which are preferably stored in a database, and which are to be mixed with the produced television video signal feed identified by the information given in the synchronization signal. Furthermore, the planning information of the schedule's entries includes timing information, when to begin an insertion of overlays into a television program and when to end the insertion. Alternatively, the entries of the schedule include timing information about the beginning and the duration of the insertion. If the schedule contains an entry for the information given in the synchronization signal, the planning information of this entry is checked. If the planning information of the schedule's entry requires the beginning of the insertion of overlays into the television program, the mixing of the overlay video signals referenced in the entry with the produced television video signal feed identified by the information given in the synchronization signal is started and continued until the end of the insertion of overlays into the television program is requested. The combined signal is then broadcast. If, however, the planning information of the schedule's entry requires the end of the insertion of overlays into the television program, the mixing is stopped and the unchanged television video signal feed is broadcast.

In another embodiment of the present invention, the synchronization signal is encoded into the closed caption line of the television video signal feed at time intervals. Usually, the overlays are inserted into the television program on an intermittent basis. Therefore, it is not necessary to continuously encode a synchronization signal into the closed caption line. The length of the time intervals is, for example, 5 seconds so that synchronization signal information is encoded into the closed caption line every 5 seconds. Speaking in terms of frames making up the pictures of the television program, the synchronization signal information is encoded into the closed caption line every nth (e.g., 120^{th}) frame. However, in order to have continuous timing information about the elapsed time of the television video signal feed, an internal timer running synchronously with the elapsed time of the television video signal feed is used. The internal timer is, if necessary, synchronised with timing information given in the synchronization signal. A synchronisation of the internal timer is necessary if, for example, the broadcast of the television video signal feed is interrupted by advertisement or news.

In a further embodiment of the present invention, the synchronization signal comprises a time code and/or a show code. The time code provides timing information about the elapsed time of the television video signal feed and preferably comprises decimal digits, for example, 013015 indicating 1 hour, 30 minutes, and 15 seconds. The show code is used to identify the television video signal feed and preferably comprises alphanumeric characters, for example, A12345. The show code and the time code are used as a reference to planning information in a schedule.

Another embodiment of the present invention cooperates with the Norpak TES5 encoder to ease the encoding of the synchronization signal into the closed caption line of the produced television video signal feed. The Norpak TES5 encoder adds supplied data to a SDI video signal which is described below. Additionally, the embodiment of the present invention supports remote control of tape decks by using the Sony 9P protocol. This eases the encoding of the synchronization signal into the closed caption line at the proper position of the produced television video signal feed if the produced television video signal feed is recorded on tape.

### BRIEF DESCRIPTION OF THE DRAWINGS

For a more complete understanding of the present invention and its features and advantages, reference is made to the following description, taken in conjunction with the accompanying drawings, in which:

FIG. 1 illustrates an exemplary scenario for the use of an embodiment of the present invention,

FIG. 2 illustrates schematically the simplified set-up of a broadcast SDI video signal, and

FIG. 3 illustrates schematically the data fields of the closed caption line.

### DESCRIPTION OF EXAMPLE EMBODIMENTS

The present invention can be embodied in the form of a method and a system for practicing the method. The present invention can also be embodied in the form of a computer program product embodied in tangible media, such as floppy diskettes, CD-ROMs, DVDs, hard drives, or any other machine-readable storage medium, wherein, when the computer program product is loaded into and executed by a machine, such as a computer or a network of interconnected computers, the machine becomes a system for practicing the invention. The present invention can also be embodied in the form of a computer program product, for example, whether stored in a storage medium, loaded into and/or executed by a machine, or transmitted over some transmission medium or carrier, such as over electrical wiring or cabling, through fiber optics, or via electromagnetic radiation, wherein, when the computer program product is loaded into and executed by a machine, such as a computer or a network of interconnected computers, the machine becomes a system for practicing the invention. When implemented on a general-purpose processor, the computer program product segments combine with the processor to provide a unique device that operates analogously to specific logic circuits.

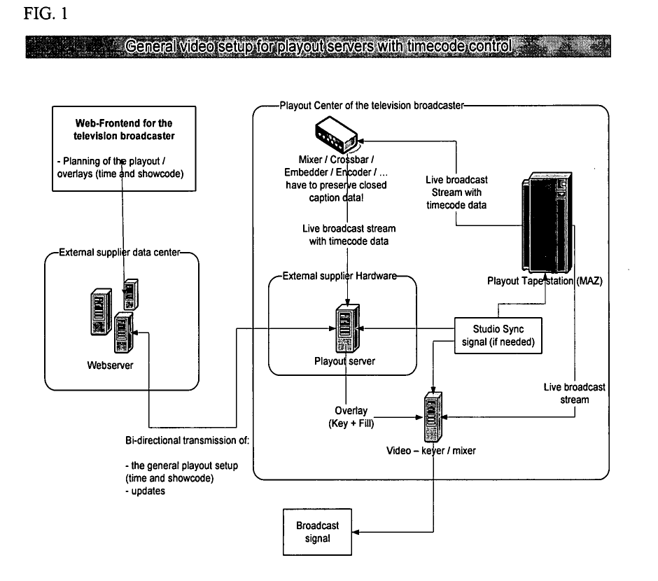

An exemplary scenario for the use of an embodiment of the present invention is illustrated in FIG. 1. In this scenario, overlay information for a produced television video signal feed is provided by an external supplier. First, the external supplier encodes a synchronization signal into the closed caption line of the produced television video signal feed in a post-production step. The synchronization signal comprises a show code and a time code. The show code is used to identify the produced television video signal feed. The time code provides timing information about the elapsed time of the produced television video signal feed. A schedule stored in a database of the external supplier contains planning information regarding the insertion of overlays into television programs. The entries of the schedule use show code and time code information as a reference to overlay video signals which are also stored in the database, and which are to be mixed with a produced television video signal feed identified by the show code information. Furthermore, the entries of the schedule include time code information, when to begin the mixing of the overlay video signals with the produced television video signal feed and when to end the mixing. In a pre-broadcast step, the produced television video signal feed including the synchronization signal is played in a playout center of a television broadcaster. During the playout, the synchronization signal encoded into the produced television video signal feed is read. If the show code information as well as the time code information of an entry of the schedule coincide with the information given in the show code and the time code of the synchronization signal, the beginning or the end of the mixing of the overlay video signals with the produced television video signal feed is initiated. If, according to the planning information given in the schedule's entry, overlays are to be inserted into the television program, the mixing of the overlay video signals referenced in the entry of the schedule with the produced television video signal feed is started and continued until the end of the insertion of overlays into the television program is requested. The combined signal is then broadcast. If, however, the planning information of the schedule's entry requires the end of the insertion of overlays into the television program, the mixing is stopped and the unchanged television video signal feed is broadcast.

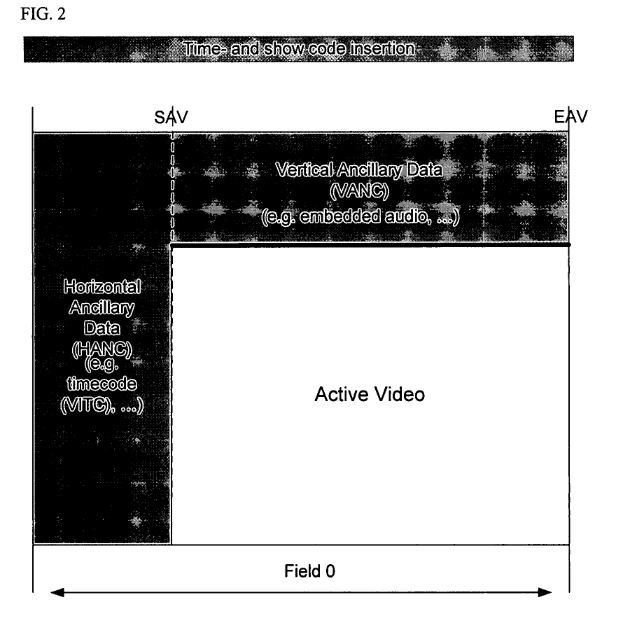

FIG. 2 illustrates schematically the simplified set-up of a broadcast SDI (Serial Digital Interface) video signal. The white rectangle represents the active picture area. The active picture area is bounded on the left by a vertical line representing the start of the active video (SAV) and on the right by a vertical line representing the end of the active video (EAV). The grey rectangle at the left of FIG. 2 symbolizes the area for horizontal ancillary data (HANC). The horizontal ancillary data are located after EAV but before SAV and often include a vertical interval time code (VITC), for example. The second grey rectangle at the top of FIG. 2 symbolizes the area for vertical ancillary data (VANC). The vertical ancillary data are located after SAV but before EAV and include, for example, embedded audio information. The active video consists of 525 lines, from which only 486 lines are used for the active picture area. In FIG. 2, the remaining 39 lines are represented by a bold horizontal line above the white rectangle illustrating the active picture area. The remaining 39 lines include the closed caption line (i.e., line 21 in the USA and line 18 in Europe). In almost every broadcast chain the data of the closed caption line is preserved whereas other data of the television video signal feed are filtered out during compression when, for example, the television video signal feed is sent over a satellite. Due to this fact, in the embodiments of the present invention, the synchronization signal is encoded into the closed caption line of the television video signal feed.

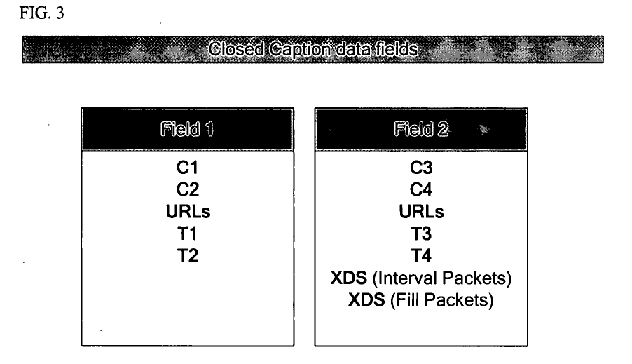

The closed caption line is subdivided into a number of data fields which are grouped into two major fields. The grouping into two major fields is not specific for the closed caption line and results from the interlace mode which is used for normal television signals in Europe and in the USA. To be able to produce higher screen frame rates (50 Hz) with lower bandwidth picture frame rates (25 Hz), each frame of the television signal is subdivided into 2 half-frames each of which only contains half of the picture information (even or odd lines). In FIG. 3, the two major fields are schematically illustrated by two rectangles named Field 1 and Field 2, respectively. Each rectangle contains a list of data fields belonging to the same major field. The data fields C1-C4 are normally used for four distinct channels of captioning information and the data fields T1-T4 are normally used for text services. Data for extended data services (XDS) and uniform resource locators (URLs) are inserted into the corresponding data fields of the same name. The data fields grouped into the same major field share bandwidth. So if one data field contains a lot of data, then there is less space left for the remaining data fields of the same major field. The synchronization signal may be encoded into each of the data fields C1-C4 and T1-T4 and it is selectable which of the data fields C1-C4 and T1-T4 is used. This allows encoding the synchronization signal into a data field of the closed caption line which is not used by another application, and which has the highest priority so that the accuracy of the synchronization signal is ensured. In FIG. 3, the order of priority of the data fields contained within a major field is given by the list of data fields in the rectangle illustrating the major field. In each list, the top most data field is assigned the highest priority. Normally, the data fields C1 and C2 of the first major field are used for subtitles so that the data fields T1 and T2 cannot be used for encoding the synchronization signal into the closed caption line because the data fields T1 and T2 have a lower priority than the data fields C1 and C2. But if only XDS data is encoded into the second major field, the data fields C3-C4 and T3-T4 can be used. If, for example, also the data field T3 is used by another application, the synchronization signal can be encoded into the data fields C3 and C4. In case the data field C4 is already used by another application, the synchronization signal is encoded into the data field C3.

The present invention provides a method, computer program product and system which allow overlay video signals to be synchronized with a television video signal feed such that the overlay video signals are mixed with the television video signal feed at the proper time intervals. This allows overlays to be easily inserted into a television program at any specific point in time without having the need to retrieve timing information from a playout system.

Although an embodiment of the present invention and its advantages are described in detail, a person skilled in the art could make various alterations, additions, and omissions without departing from the spirit and scope of the present invention as defined by the appended claims.

What is claimed is:

1. A method for synchronising overlay video signals with a television video signal feed, comprising:
encoding a synchronization signal into the closed caption line of the television video signal feed during or after production of the television video signal feed;
reading the synchronization signal during playout of the television video signal feed; and
mixing overlay video signals with the television video signal feed based on the synchronization signal.

2. The method of claim 1, wherein the synchronization signal is encoded into the closed caption line of the television video signal feed at time intervals.

3. The method of claim 1, wherein the synchronization signal comprises a time code and/or a show code.

4. A method for synchronising overlay video signals with a television video signal feed, the method comprising the step of
encoding a synchronization signal into the closed caption line of the television video signal feed during or after production of the television video signal feed, wherein
the synchronization signal is indicative of the timing of the television video signal feed and is readable during playout of the television video signal feed in order to provide a reference for mixing overlay video signals with the television video signal feed.

5. The method of claim 4, wherein the synchronization signal is encoded into the closed caption line of the television video signal feed at time intervals.

6. The method of claim 4, wherein the synchronization signal comprises a time code and/or a show code.

7. A computer program product for synchronising overlay video signals with a television video signal feed, the computer program product embodied in a computer-readable medium and when executed by a computer operable to:
encode a synchronization signal into the closed caption line of the television video signal feed during or after production of the television video signal feed;
read the synchronization signal during playout of the television video signal feed; and
mix overlay video signals with the television video signal feed based on the synchronization signal.

8. The computer program product of claim 7, wherein the synchronization signal is encoded into the closed caption line of the television video signal feed at time intervals.

9. The computer program product of claim 7, wherein the synchronization signal comprises a time code and/or a show code.

10. A computer program product for synchronising overlay video signals with a television video signal feed, the computer program product embodied in a computer-readable medium and when executed by a computer operable to:
encode a synchronization signal into the closed caption line of the television video signal feed during or after production of the television video signal feed, wherein
the synchronization signal is indicative of the timing of the television video signal feed and is readable during playout of the television video signal feed in order to provide a reference for mixing overlay video signals with the television video signal feed.

11. The computer program product of claim 10, wherein the synchronization signal is encoded into the closed caption line of the television video signal feed at time intervals.

12. The computer program product of claim 10, wherein the synchronization signal comprises a time code and/or a show code.

13. A system for synchronising overlay video signals with a television video signal feed, comprising:
a database operable to store schedule data and/or overlay data and
a computer system coupled to the database and operable to:
encode a synchronization signal into the closed caption line of the television video signal feed during or after production of the television video signal feed;
read the synchronization signal during playout of the television video signal feed; and
mix overlay video signals with the television video signal feed based on the synchronization signal.

14. The system of claim 13, wherein the synchronization signal is encoded into the closed caption line of the television video signal feed at time intervals.

15. The system of claim 13, wherein the synchronization signal comprises a time code and/or a show code.

16. A system for synchronising overlay video signals with a television video signal feed, comprising:
a database operable to store schedule data and/or overlay data and
a computer system coupled to the database and operable to:
encode a synchronization signal into the closed caption line of the television video signal feed during or after production of the television video signal feed, wherein
the synchronization signal is indicative of the timing of the television video signal feed and is readable during playout of the television video signal feed in order to provide a reference for mixing overlay video signals with the television video signal feed.

17. The system of claim 16, wherein the synchronization signal is encoded into the closed caption line of the television video signal feed at time intervals.

18. The system of claim 16, wherein the synchronization signal comprises a time code and/or a show code.
